(19) United States
(12) Patent Application Publication
(10) Pub. No.: US 2025/0250174 A1
(43) Pub. Date: Aug. 7, 2025

(54) HYDROGENCARBONATE PRODUCING SYSTEM AND HYDROGENCARBONATE PRODUCING METHOD

(71) Applicant: TOYOTA JIDOSHA KABUSHIKI KAISHA, Toyota-shi (JP)

(72) Inventors: Masahiko TAKEUCHI, Toyota-shi (JP); Koseki Sugiyama, Sunto-gun (JP); Yoshiteru Yazawa, Nagoya-shi (JP); Akira Kato, Toyota-shi (JP); Yuki Takahashi, Miyoshi-shi (JP)

(73) Assignee: TOYOTA JIDOSHA KABUSHIKI KAISHA, Toyota-shi (JP)

(21) Appl. No.: 19/038,907

(22) Filed: Jan. 28, 2025

(30) Foreign Application Priority Data
Feb. 5, 2024 (JP) 2024-015748

(51) Int. Cl. C01B 32/60; B01D 53/60

(52) U.S. Cl. CPC C01B 32/60; B01D 53/60; B01D 2256/22; B01D 2257/302; B01D 2257/404; B01D 2258/02

(57) ABSTRACT

A hydrogencarbonate generation system according to the present disclosure includes a removing device that removes acidic substances in a first exhaust gas to generate a second exhaust gas, a hydrogencarbonate producing device that reacts carbon dioxide in at least one of the first exhaust gas and the second exhaust gas with an alkaline earth compound in a reaction solution to produce hydrogencarbonate, and a pH sensor that detects the pH of the reaction solution. An introduction amount of the first exhaust gas and an introduction amount of the second exhaust gas that are to be introduced into the hydrogencarbonate producing device are controlled to maintain the pH of the reaction solution detected by the pH sensor within a predetermined target pH range.

### CROSS-REFERENCE TO RELATED APPLICATION

This application claims priority to Japanese Patent Application No. 2024-015748 filed on Feb. 5, 2024, incorporated herein by reference in its entirety.

### BACKGROUND

### 1. Technical Field

The present disclosure relates to a hydrogencarbonate producing system and a hydrogencarbonate producing method.

### 2. Description of Related Art

Japanese Unexamined Patent Application Publication No. 2018-051554 discloses a technique for recovering carbon dioxide (hereinafter also referred to as CO₂) from exhaust gases from factories, etc.

The recovered CO₂ is reacted with, for example, an alkaline earth compound to produce carbonate or hydrogencarbonate, thereby immobilizing the recovered CO₂.

### SUMMARY

The inventors have been studying that CO₂ in an exhaust gas is reacted with an alkaline earth compound in water to produce hydrogencarbonate, and have found the following problems.

Here, if the pH of a reaction solution in which CO₂ and the alkaline earth compound are reacted with each other is too high, carbonate is more likely to be produced rather than hydrogencarbonate. On the other hand, if the pH of the reaction solution is too low, there is also a problem that hydrogencarbonate is less likely to be produced.

The present disclosure has been made in consideration of the above circumstances, and provides a hydrogencarbonate producing system capable of efficiently producing hydrogencarbonate.

A hydrogencarbonate producing system according to the present disclosure includes:
a removing device that removes acidic substances in a first exhaust gas to produce second exhaust gas;
a hydrogencarbonate producing device that reacts carbon dioxide in at least one of the first exhaust gas and the second exhaust gas with an alkaline earth compound in a reaction solution to produce hydrogencarbonate; and
a pH sensor that detects pH of the reaction solution, wherein an introduction amount of the first exhaust gas and an introduction amount of the second exhaust gas that are to be introduced into the hydrogencarbonate producing device are controlled to maintain the pH of the reaction solution detected by the pH sensor within a predetermined target pH range.

In the hydrogencarbonate producing system according to an aspect of the present disclosure, the introduction amount of the first exhaust gas to be introduced into the hydrogencarbonate producing device before the removal of acidic substances and the introduction amount of the second exhaust gas to be introduced into the hydrogencarbonate producing device after the removal of acidic substances are controlled such that the pH of the reaction solution in the hydrogencarbonate producing device detected by the pH sensor is maintained within the predetermined target pH range. Therefore, the pH of the reaction solution can be maintained within the predetermined target pH range, and hydrogencarbonate can be produced efficiently.

When the pH detected by the pH sensor is higher than the predetermined target pH range, the introduction amount of the first exhaust gas may be increased, and when the pH is lower than the predetermined target pH range, the introduction amount of the second exhaust gas may be increased.

Furthermore, the acidic substances may include at least one of nitrogen oxide and sulfur oxide.

Furthermore, the alkaline earth compound is contained in incinerated ash, slag, or seawater.

A method for producing hydrogencarbonate according to an aspect of the present disclosure includes:
a step of removing acidic substances in a first exhaust gas to generate a second exhaust gas; and
a step of reacting carbon dioxide in at least one of the first exhaust gas and the second exhaust gas with an alkaline earth compound in a reaction solution to produce hydrogencarbonate, wherein pH of the reaction solution is detected, and an introduction amount of the first exhaust gas and an introduction amount of the second exhaust gas in a process of producing the hydrogencarbonate are controlled to maintain the detected pH of the reaction solution within a predetermined target pH range.

In the method for producing hydrogencarbonate according to the aspect of the present disclosure, the pH of the reaction solution in the step of producing hydrogencarbonate is detected, and the introduction amount of the first exhaust gas to be introduced before the removal of acidic substances and the introduction amount of the second exhaust gas to be introduced after the removal of acidic substances in the step of producing hydrogencarbonate are controlled to maintain the detected pH of the reaction solution within the predetermined target pH range. Therefore, the pH of the reaction solution can be maintained within the predetermined target pH range, and hydrogencarbonate can be produced efficiently.

According to the present disclosure, a hydrogencarbonate producing system capable of efficiently producing hydrogencarbonate can be provided.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration of a hydrogencarbonate producing system according to a first embodiment;

FIG. 2 is a flowchart showing a hydrogencarbonate producing method according to the first embodiment; and

FIG. 3 is a flowchart showing a control method for controlling the pH of reaction solution in a hydrogencarbonate producing device 200 in step ST2 of FIG. 2.

### DETAILED DESCRIPTION OF EMBODIMENTS

Specific embodiments of the present disclosure will be described hereunder in detail with reference to the drawings. However, the present disclosure is not limited to the following embodiments. Furthermore, the following description and drawings are simplified as appropriate for clarity of description.

### First Embodiment

### Configuration of Hydrogencarbonate Producing System

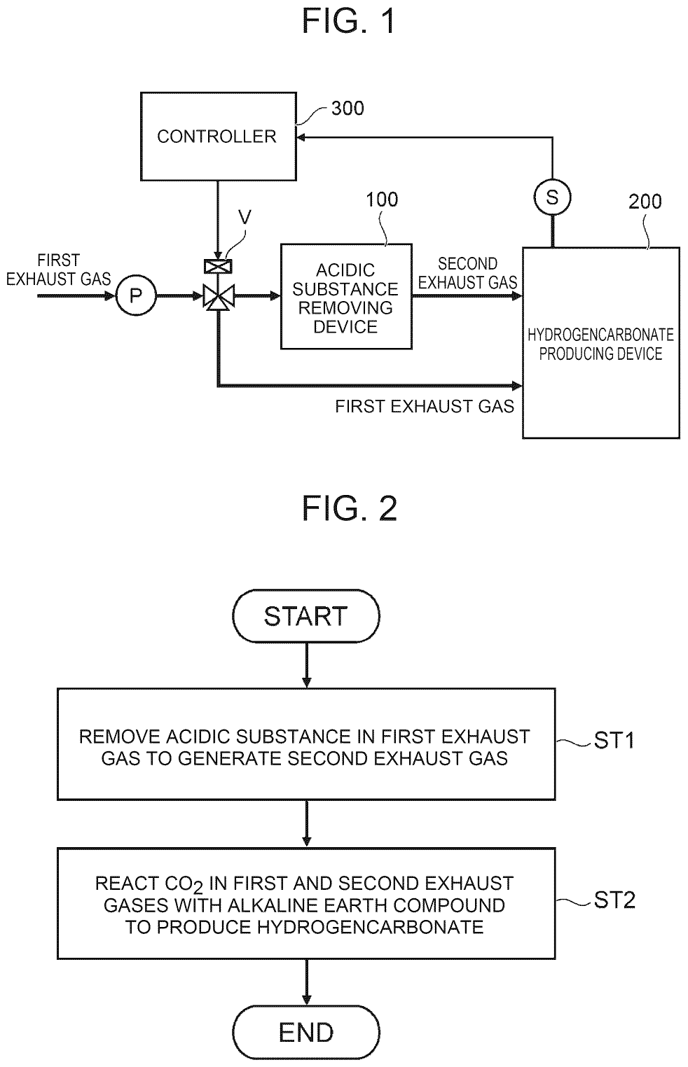

First, a configuration of a hydrogencarbonate producing system according to a first embodiment will be described with reference to FIG. 1. FIG. 1 is a block diagram showing the configuration of the hydrogencarbonate producing system according to the first embodiment. In FIG. 1, thick arrows indicate the flow of gas, and thin arrows indicate the flow of signals.

As shown in FIG. 1, the hydrogencarbonate producing system according to the present embodiment includes an acidic substance removing device 100, a hydrogencarbonate producing device 200, a controller 300, a suction pump P, a three-way valve V, and a sensor S.

As shown in FIG. 1, the acidic substance removing device 100 removes acidic substances in a first exhaust gas to produce a second exhaust gas, and outputs the second exhaust gas. The first exhaust gas is, for example, an exhaust gas from a factory or the like that contains a higher concentration of CO2 than the atmosphere, and contains, for example, nitrogen oxides (NOₓ), sulfur oxides (SOₓ), and the like as acidic substances. Although not particularly limited, the acidic substance removing device 100 is, for example, a wet scrubber.

In an example shown in FIG. 1, the first exhaust gas that has been suctioned by a suction pump P from a factory (not shown) is introduced into the acidic substance removing device 100 via the three-way valve V. Then, the second exhaust gas from which the acidic substances in the first exhaust gas have been removed by the acidic substance removing device 100 is introduced into a hydrogencarbonate producing device 200. On the other hand, the first exhaust gas suctioned by the suction pump P is also directly introduced into the hydrogencarbonate producing device 200 via the three-way valve V.

In other words, the three-way valve V switches the supply destination of the first exhaust gas to either the acidic substance removing device 100 or the hydrogencarbonate producing device 200. Here, the ratio between the amount of the first exhaust gas to be introduced into the acidic substance removing device 100 and the amount of the first exhaust gas to be introduced into the hydrogencarbonate producing device 200 may be changed by the three-way valve V. By using such a configuration, it is possible to control the amount of the first exhaust gas which is to be introduced into the hydrogencarbonate producing device 200 and from which the acidic substances have not been removed, and the amount of the second exhaust gas which is to be introduced into the hydrogencarbonate producing device 200 and from which the acidic substances have been removed.

Note that the means for switching the supply destination of the first exhaust gas is not limited to the three-way valve shown in FIG. 1, and may be configured by, for example, two on-off valves.

As shown in FIG. 1, the controller 300 controls the introduction amount of the first exhaust gas and the introduction amount of the second exhaust gas that are to be introduced into the hydrogencarbonate producing device 200 such that the pH of reaction solution in the hydrogencarbonate producing device 200 detected by the sensor S is maintained within a predetermined target pH range. In the example shown in FIG. 1, the controller 300 controls the three-way valve V based on the pH of the reaction solution in the hydrogencarbonate producing device 200 detected by the sensor S.

Here, when the pH of the reaction solution detected by the sensor S is higher than the predetermined target pH range, carbonate is more likely to be produced in the hydrogencarbonate producing device 200 instead of hydrogencarbonate. Therefore, in order to lower the pH of the reaction solution, the controller 300 controls the three-way valve V to increase the introduction amount of the first exhaust gas from which the acidic substances have not been removed. For example, the controller 300 controls the three-way valve V to switch the supply destination of the first exhaust gas from the acidic substance removing device 100 to the hydrogencarbonate producing device 200. Alternatively, the controller 300 may control the three-way valve V to increase the ratio of the introduction amount of the first exhaust gas to be introduced into the hydrogencarbonate producing device 200.

On the other hand, when the pH of the reaction solution detected by the sensor S is lower than the predetermined target pH range, it is difficult to generate hydrogencarbonate in the hydrogencarbonate producing device 200. Therefore, in order to increase the pH of the reaction solution, the controller 300 controls the three-way valve V to increase the introduction amount of the second exhaust gas from which the acidic substances have been removed. For example, the controller 300 controls the three-way valve V to switch the supply destination of the first exhaust gas from the hydrogencarbonate producing device 200 to the acidic substance removing device 100. Alternatively, the controller 300 may control the three-way valve V to increase the ratio of the introduction amount of the second exhaust gas to be introduced into the hydrogencarbonate producing device 200.

Here, as not shown in FIG. 1, the controller 300 includes a calculation unit such as a central processing unit (CPU), memories such as a random access memory (RAM) and a read only memory (ROM) in which various programs, data, etc. are stored. In other words, the controller 300 has a function as a computer, and executes various processing based on the various programs, etc.

The first exhaust gas and the second exhaust gas are introduced into the hydrogencarbonate producing device 200, and CO₂ in the first exhaust gas and the second exhaust gas is reacted with an alkaline earth compound to produce hydrogencarbonate. Here, the hydrogencarbonate is hydrogencarbonate of an alkaline earth metal, and it is also called bicarbonate.

The alkaline earth compound may be added as it is, but it is preferable to use incinerated ash, slag, seawater, or the like from the viewpoint of reducing the environmental load. Incinerated ash or the like may be used as it is, or incinerated ash or the like from which compounds hindering CO₂ fixation have been removed in advance may be used. In other words, the incinerated ash or the like may contain components other than alkaline earth compounds as long as the incinerated ash or the like can fix CO₂.

The alkaline earth compounds are compounds containing alkaline earth metal elements, and they are, for example, water-soluble alkaline earth compounds. Examples of the water-soluble alkaline earth compounds include an alkaline earth metal oxide, an alkaline earth metal nitrate, an alkaline earth metal hydroxide, and mixtures thereof.

Suitable examples of alkaline earth metals include Be, Ca, Mg, Sr, Ba, Ra, and combinations thereof. Suitable examples of alkaline earth metal oxides include CaO, MgO, SrO, BaO, or combinations thereof, examples of alkaline earth metal nitrates include Ca(NO₃)₂, Mg(NO₃)₂, Sr(NO₃)₂, Ba(NO₃)₂, and combinations thereof, and examples of alkaline earth metal hydroxides include Ca(OH)₂, Mg(OH)₂, Sr(OH)₂, Ba(OH)₂, and combinations thereof. Specific examples of hydrogencarbonate include Ca(HCO₃)₂, Mg(HCO₃)₂, Sr(HCO₃)₂, Ba(HCO₃)₂, and combinations thereof.

When water is used as a solvent and the incinerated ash contains calcium oxide, for example, carbonate ions are consumed and carbonate salts are produced through the following reaction. When carbonate ions are further supplied, hydrogencarbonate is produced.

CaO+H₂O→Ca₂₊+2OH⁻

CO₂+H₂O→2H⁺+CO₃²⁻

Ca²⁺+CO₃²⁻→CaCO₃

CaCO₃+2H⁺+CO₃²⁻→Ca(HCO₃)₂

As shown in FIG. 1, the sensor S detects the pH of the reaction solution in the hydrogencarbonate producing device 200. The sensor S is not limited to specific one as long as it can detect the pH of the reaction solution in the hydrogencarbonate producing device 200, but it is, for example, a pH sensor using a glass electrode method.

The target pH range of the reaction solution is a concentration range in

which hydrogencarbonate can be efficiently produced. The target pH range of the reaction solution is not particularly limited, but it is, for example, 5 to 11, preferably 6.5 to 10.5, and more preferably 7 to 9.5. Here, when the pH of the reaction solution in which CO₂ and an alkaline earth compound are reacted with each other exceeds 11, carbonate is more likely to be produced instead of hydrogencarbonate. On the other hand, when the pH of the reaction solution falls below 5, hydrogencarbonate is less likely to be produced.

As described above, in the hydrogencarbonate producing system according to the present embodiment, the introduction amount of the first exhaust gas to be introduced into the hydrogencarbonate producing device 200 and the introduction amount of the second exhaust gas to be introduced into the hydrogencarbonate producing device 200 are controlled to maintain the pH of the reaction solution in the hydrogencarbonate producing device 200 within a predetermined target pH range. Therefore, the pH of the reaction solution can be maintained within the predetermined target pH range, and hydrogencarbonate can be produced efficiently.

### Method for Producing Hydrogencarbonate

Next, a method for producing hydrogencarbonate according to the first embodiment will be described with reference to FIG. 2. FIG. 2 is a flowchart showing the method for producing hydrogencarbonate according to the first embodiment. The description of FIG. 2 will be made while referring to FIG. 1 as appropriate.

First, as shown in FIG. 2, the acidic substances in the first exhaust gas are removed by the acidic substance removing device 100 to generate the second exhaust gas (step ST1).

Then, as shown in FIG. 2, in the hydrogencarbonate producing device 200 shown in FIG. 1, carbon dioxide and an alkaline earth compound in at least one of the first exhaust gas and the second exhaust gas are reacted with each other in the reaction solution to produce hydrogencarbonate (step ST2). Here, as shown in FIG. 1, the first exhaust gas from which the acidic substances have not been removed and the second exhaust gas from which the acidic substances have been removed can be introduced into the hydrogencarbonate producing device 200.

In the method for producing hydrogencarbonate according to the present embodiment, in step ST2, the introduction amount of the first exhaust gas to be introduced into the hydrogencarbonate producing device 200 and the introduction amount of the second exhaust gas to be introduced into the hydrogencarbonate producing device 200 are controlled such that the pH of the reaction solution in the hydrogencarbonate producing device 200 is kept within a predetermined target pH range.

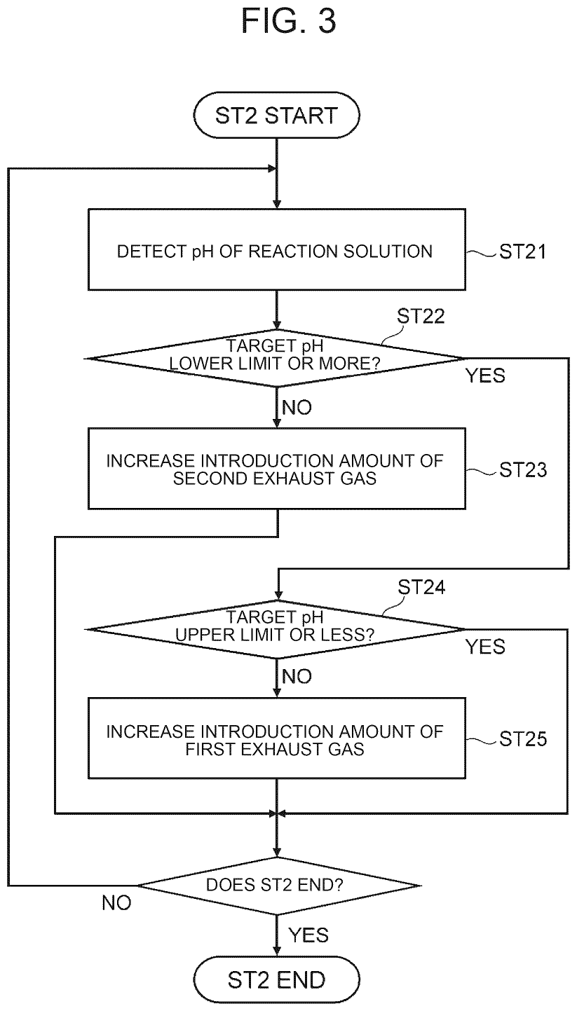

Here, FIG. 3 is a flowchart showing a control method for controlling the pH of the reaction solution in the hydrogencarbonate producing device 200 in step ST2 of FIG. 2.

First, as shown in FIG. 3, when step ST2 is started, the pH of the reaction solution in the hydrogencarbonate producing device 200 is detected by the sensor S (step ST21).

Next, the controller 300 determines whether the pH of the reaction solution detected by the sensor S is equal to or higher than a lower limit of a predetermined target pH range (step ST22). If the detected pH of the reaction solution is lower than the lower limit of the target pH range (NO in step ST22), it becomes difficult to produce hydrogencarbonate in the hydrogencarbonate producing device 200. Therefore, in order to increase the pH of the reaction solution, the controller 300 controls the three-way valve V to increase the introduction amount of the second exhaust gas from which the acidic substances have been removed (step ST23). Thereafter, if step ST2 does not end, the process returns to step ST21.

On the other hand, if the detected pH of the reaction solution is equal to or higher than the lower limit of the target pH range (YES in step ST22), the controller 300 determines whether the detected pH of the reaction solution is equal to or lower than an upper limit of the predetermined target pH range (step ST24).

If the detected pH of the reaction solution is higher than the upper limit of the predetermined target pH range (NO in step ST24), carbonate is more likely to be produced in place of hydrogencarbonate in the hydrogencarbonate producing device 200. Therefore, in order to lower the pH of the reaction solution, the controller 300 controls the three-way valve V to increase the introduction amount of the first exhaust gas from which the acidic substances have not been removed (step ST25). Thereafter, if step ST2 does not end, the process returns to step ST21.

If the detected pH of the reaction solution is equal to or lower than the upper limit of the predetermined target pH range (YES in step ST24), and the process directly returns to step ST21 if step ST2 has not ended.

As shown in FIG. 3, the controller 300 repeatedly executes the processes of steps ST21 to ST25 described above from the start until the end of step ST2.

The determination in step ST22 and step ST23 for increasing the introduction amount of the second exhaust gas are performed as a set. The determination in step ST24 and step ST25 for increasing the introduction amount of the first exhaust gas are also performed as a set. In FIG. 3, the determination in step ST22 is performed preferentially for convenience, but the determination in step ST24 may be performed preferentially, or the determinations in steps ST22 and ST24 may be performed simultaneously.

As described above, in the hydrogencarbonate producing method according to the present embodiment, the introduction amount of the first exhaust gas to be introduced into the hydrogencarbonate producing device 200 and the introduction amount of the second exhaust gas to be introduced into the hydrogencarbonate producing device 200 are controlled to maintain the pH of the reaction solution in the hydrogencarbonate producing device 200 within a predetermined target pH range. Therefore, the pH of the reaction solution can be maintained within the predetermined target pH range, and hydrogencarbonate can be produced efficiently.

Note that the present disclosure is not limited to the above-described embodiment, and can be modified as appropriate without departing from the gist of the present disclosure.

The present disclosure also contributes to carbon neutrality, decarbonization, and the sustainable development goals (SDGs).

What is claimed is:

1. A hydrogencarbonate producing system comprising:
a removing device that removes acidic substances in a first exhaust gas to produce a second exhaust gas;
a hydrogencarbonate producing device that reacts carbon dioxide in at least one of the first exhaust gas and the second exhaust gas with an alkaline earth compound in a reaction solution to produce hydrogencarbonate; and
a pH sensor that detects pH of the reaction solution, wherein an introduction amount of the first exhaust gas and an introduction amount of the second exhaust gas that are to be introduced into the hydrogencarbonate producing device are controlled to maintain the pH of the reaction solution detected by the pH sensor within a predetermined target pH range.

2. The hydrogencarbonate producing system according to claim 1, wherein when the pH detected by the pH sensor is higher than the predetermined target pH range, the introduction amount of the first exhaust gas is increased, and when the pH is lower than the predetermined target pH range, the introduction amount of the second exhaust gas is increased.

3. The hydrogencarbonate producing system according to claim 1, wherein the acidic substances include at least one of nitrogen oxide and sulfur oxide.

4. The hydrogencarbonate producing system according to claim 1, wherein the alkaline earth compound is contained in incinerated ash, slag, or seawater.

5. A method for producing hydrogencarbonate, comprising:
a step of removing acidic substances in a first exhaust gas to generate a second exhaust gas; and
a step of reacting carbon dioxide in at least one of the first exhaust gas and the second exhaust gas with an alkaline earth compound in a reaction solution to produce hydrogencarbonate, wherein pH of the reaction solution is detected, and an introduction amount of the first exhaust gas and an introduction amount of the second exhaust gas in the process of producing hydrogencarbonate are controlled to maintain the detected pH of the reaction solution within a predetermined target pH range.
